(19) United States
(12) Patent Application Publication
(10) Pub. No.: US 2009/0283243 A1
(43) Pub. Date: Nov. 19, 2009

(54) HEAT DISSIPATION DEVICE

(75) Inventor: Xin-Xiang Zha, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 12/261,044

(22) Filed: Oct. 30, 2008

(30) Foreign Application Priority Data
May 16, 2008 (CN) 200810067262.4

(51) Int. Cl. F28F 7/00; F16B 21/00

(52) U.S. Cl. 165/80.3; 411/347

(57) ABSTRACT

A securing structure of a heat dissipation device for an electronic component includes a fastener and a securing arm. The fastener includes a bolt and a spring surrounding the bolt. The bolt includes a main portion, a bottom fixing portion and a top head portion. An aperture extends inwardly from a free end of the securing arm with a width not smaller than the main portion and smaller than the fixing portion. The main portion of the bolt is received in the aperture with the spring compressed between an upper surface of the securing arm and the head portion, and the fixing portion abutting a lower surface of the securing arm. An engaging portion extends perpendicularly from the securing arm around the aperture and engages with the fastener to hold the fastener in the aperture of the securing arm.

### BACKGROUND

1. Field of the Disclosure

The disclosure generally relates to a heat dissipation device, and particularly to a securing structure of the heat dissipation device.

2. Description of Related Art

With the continuing development of the electronic technology, electronic packages, such as CPUs, are generating more and more heat which requires immediate dissipation. A thermal module is usually mounted on the electronic component for dissipating heat generated thereby, and a plurality of mounting elements are needed for securing the thermal module onto the electronic component. Generally each mounting element includes a bolt defining an annular groove near a bottom thereof, a spring disposed around a top of the bolt, and a ring-like clipping member. After the bolts extend through the thermal module, the clipping members expand radially and outwardly to snap in the grooves of the bolts, thereby pre-assembling the bolts to the thermal module.

However, during the pre-assembling process, there is no mechanism formed in the bolts which can reliably ensure the snapping of the clipping members into the grooves of the bolts; the clipping members may be mounted to screwed end portions of the bolts if the clipping members are not aligned with the grooves. When this happens, the clipping members could drop from the bolts during transportation of the pre-assembled thermal module. In addition, after the thermal module is assembled to the electronic component, the clipping members are no longer needed. As the clipping members are made of metal with good resiliency, a cost of the thermal module is increased by using the clipping members.

For the foregoing reasons, therefore, there is a need in the art for a securing structure of the heat dissipation device which overcomes the above-mentioned problems.

### SUMMARY

According to an exemplary embodiment of the disclosure, a heat dissipation device includes a heat sink and a securing structure for assembling the heat sink to a heat generating component. The heat sink includes a base, a trunk extending through the base, and a fin unit located above the base. The trunk has a bottom surface being configured for thermally attaching to the heat generating component. The fin unit attaches to an outer circumferential surface of the trunk closely. The securing structure includes at least a fastener and a securing arm extending from the base. The fastener includes a bolt and a spring. The bolt includes a main portion, a fixing portion formed at a bottom end of the main portion with a diameter greater than that of the main portion, and a head portion formed at a top end of the main portion with a diameter greater than that of the main portion. The spring is mounted around the main portion of the bolt. The securing arm has an aperture extending inwardly from a free end thereof with a width not smaller than the diameter of the main portion and smaller than the diameter of the fixing portion of the bolt. The main portion of the bolt enters into the aperture with the spring resiliently compressed between an upper surface of the securing arm and the head portion of the bolt, and the fixing portion of the bolt abutting a lower surface of the securing arm. An engaging portion extends vertically from the securing arm around the aperture and engages with the fastener to hold the fastener in the aperture of the securing arm.

Other advantages and novel features of the disclosure will be drawn from the following detailed description of the exemplary embodiments of the disclosure with attached drawings.

### BRIEF DESCRIPTION OF THE DRAWINGS

FIG. 1 is an isometric, exploded view of a heat dissipation device according to an exemplary embodiment.

FIG. 2 is an assembled view of a portion of a securing structure of the heat dissipation device of FIG. 1.

FIG. 3 is a cross section view of the securing structure taken along line III-III of FIG. 2.

FIG. 4 is an isometric view of the securing structure according to an alternative embodiment, wherein one fastener is separated from a securing arm of a base.

FIG. 5 shows an inverted view of the securing structure of FIG. 4.

FIG. 6 is an exploded view of a portion of the securing structure according to a third embodiment.

FIG. 7 is an assembled view of the portion of the securing structure of FIG. 6.

FIG. 8 is a cross section view of the portion of the securing structure of FIG. 7 taken along line VIII-VIII.

### DETAILED DESCRIPTION OF THE EMBODIMENTS

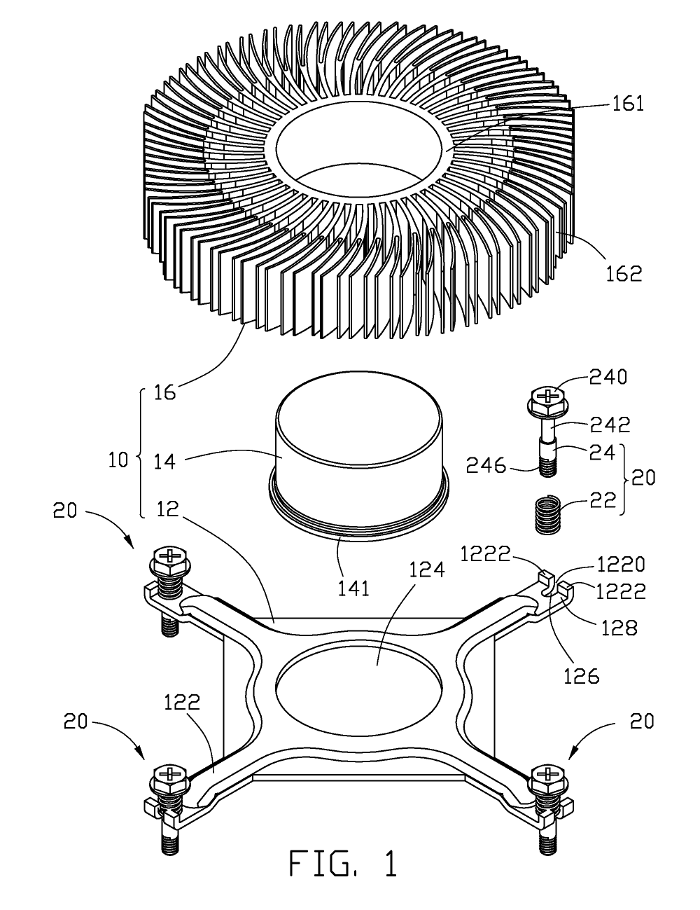

Referring to FIG. 1, a heat dissipation device according to an exemplary embodiment includes a heat sink 10 and a plurality of fasteners 20.

The heat sink 10 includes a base 12, a trunk 14, and a fin unit 16. The base 12 is rectangular, and defines a circular hole 124 in a center thereof. The trunk 14 is column-shaped and solid. The trunk 14 is made of copper which has a high heat conductivity coefficient. The trunk 14 has a diameter approximately the same as that of the circular hole 124 of the base 12. An annular flange 141 extends radially and outwardly from a bottom end of the trunk 14. An outer diameter of the flange 141 is greater than the diameter of the circular hole 124 of the base 12. The fin unit 16 includes a cylinder 161 and a plurality of fins 162 extending radially and integrally from an outer circumferential surface of the cylinder 161. Each fin 162 is curved. An inner diameter of the cylinder 161 is substantially equal to the diameter of the trunk 14.

When the heat sink 10 is assembled together, the trunk 14 extends upwardly through the circular hole 124 of the base 12 with the flange 141 thereof engaging with a bottom surface of the base 12. The cylinder 161 of the fin unit 16 is mounted around the trunk 14 and attaches to an outer circumferential surface of the trunk 14 closely. The fins 162 are thus located over the base 12 and surround the trunk 14. During operation of the heat dissipation device, a bottom surface of the trunk 14 is thermally attached to a heat generating component (not shown), such as a central processing unit (CPU) mounted on a circuit board (not shown), to absorb heat therefrom. The heat is then quickly conducted by the trunk 14 to the fins 162 for dissipation.

Four securing arms 122 extend outwardly from four corners of the base 12 respectively. Each fastener 20 extends through one securing arm 122 to engage with the circuit board on which the heat generating component is mounted. The securing arms 122 of the base 12 and the fasteners 20 cooperatively construct a securing structure for assembling the heat dissipation device to the circuit board. Each fastener 20 includes a bolt 24 and a spring 22 mounted around the bolt 24. The bolt 24 has a glazed column-shaped main portion 242, a head portion 240 positioned at a top end of the main portion 242, and a threaded fixing portion 246 formed at a bottom end of the main portion 242. The main portion 242 has a diameter smaller than that of the fixing portion 246. The diameter of the fixing portion 246 is smaller than that of the spring 22. The diameter of the spring 22 is smaller than that of the head portion 240, and is smaller than a width of the securing arm 122.

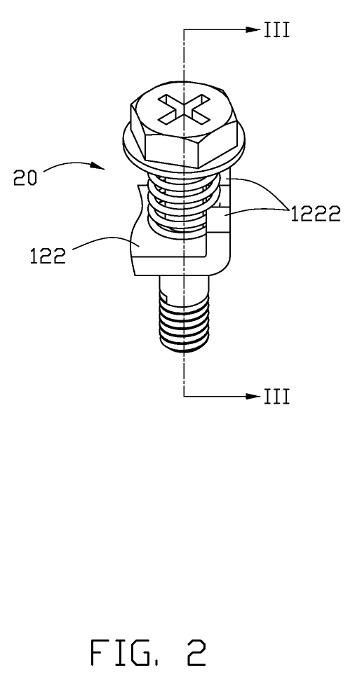

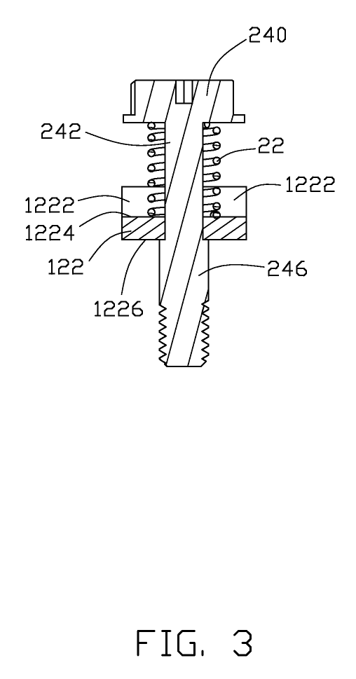

Also referring to FIGS. 2 and 3, an aperture 126 extends inwardly from a free end of each securing arm 122. Each aperture 126 extends through the securing arm 122 in a vertical direction for extension of the corresponding fastener 20 therethrough. The aperture 126 is substantially U-shaped in a top view as shown in FIG. 1. An inner side of the aperture 126 is substantially semi-circular, and an outer side of the aperture 126 is open to communicate with an outside. A length of the aperture 126 is a little smaller than the diameter of the spring 22 of the fastener 20. A width of the aperture 126 is substantially equal to the main portion 242 of the bolt 24. Alternatively, the width of the aperture 126 can be a little greater than the diameter of the main portion 242, but should be smaller than the diameter of the fixing portion 246 of the bolt 24. A pair of supporting portions 128 are formed at the free end of the securing arm 122 and located at two opposite sides of the aperture 126. An engaging portion 1222 extends upwardly and vertically from an outer end of each supporting portion 128. A sum of a thickness of the securing arm 122 and a height of the engaging portion 1222 is smaller than a height of the main portion 242 of the bolt 24. An opening 1220 is defined between the two engaging portions 1222 with a width equal to that of the aperture 126. The opening 1220 is located above and communicates with the aperture 126.

In pre-assembly of the fasteners 20 to the heat sink 10, each bolt 24 with the spring 22 surrounding the main portion 242 thereof is placed beside the free end of the securing arm 122 and confronts the opening 1220. The spring 22 is resiliently compressed towards the head portion 240 of the bolt 24 to expose the main portion 242 of the bolt 24. The head portion 240 and an upper part of the main portion 242 with the compressed spring 22 are located above the engaging portion 1222 of the securing arm 122, and the fixing portion 246 of the bolt 24 is located below the securing arm 122. Thus a lower part of the main portion 242 without the compressed spring 22 can enter into the aperture 126 via the opening 1220 and the open outer side of the aperture 126. After the main portion 242 of the bolt 24 moved to abut the arc-shaped inner side of the aperture 126, the compressing force on spring 22 is released, whereby the spring 22 expands downwardly to abut against an upper surface 1224 of the securing arm 122. On the influence of the elastic restoring force of the compressed spring 22, the fixing portion 246 of the bolt 24 is lifted to abut against a lower surface 1226 of the securing arm 122. In this situation, the spring 22 is resiliently compressed between the upper surface 1224 of the securing arm 122 and the head portion 240 of the bolt 24.

As the width of the opening 1220 is substantially equal to the main portion 242 of the bolt 24 and smaller than the diameter of the spring 22, an outer periphery of a lower portion of the spring 22 abuts the engaging portions 1222. By the engagement between the engaging portions 1222 of the securing arms 122 and the springs 22 of the fasteners 20, the fasteners 20 are pre-assembled to the heat sink 10 reliably and held still in the apertures 126 of the securing arms 122, and will not be easily disassembled from the pre-assembled position even during transportation. When assembling the heat dissipation device to the electronic component, the head portion 240 of each bolt 24 is pressed downwardly and continuously rotated to cause the fixing portion 246 to completely threadedly engage with a back plate (not shown) of the circuit board. The electronic component is thus sandwiched between the circuit board and the heat dissipation device, and intimately contacts with the bottom surface of the trunk 14 of the heat sink 10 for dissipation of heat.

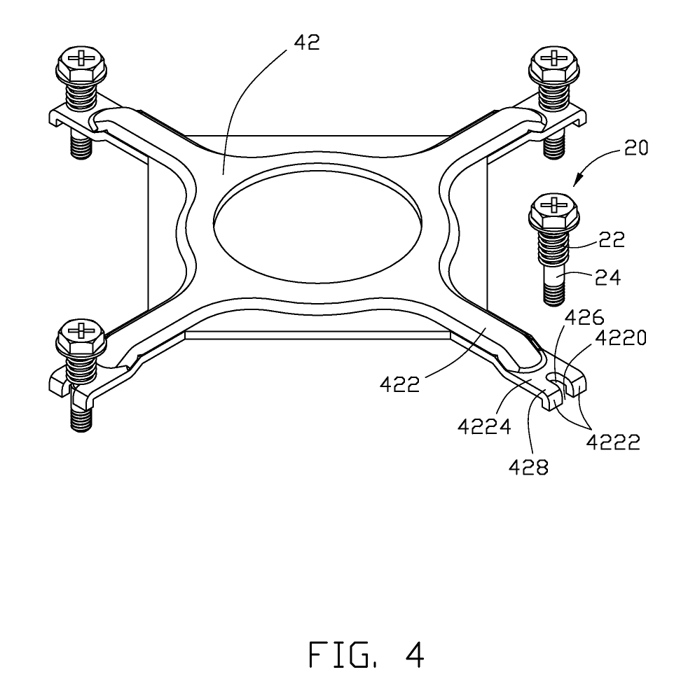

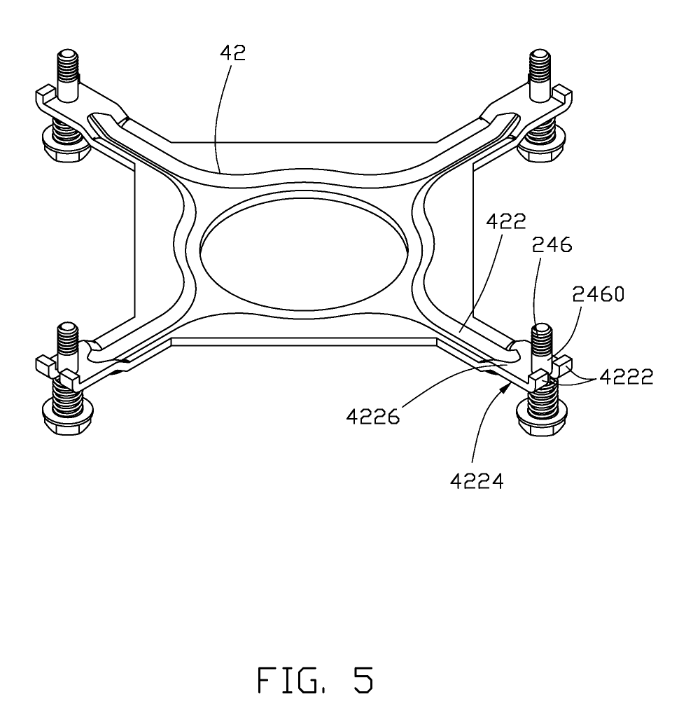

Referring to FIGS. 4 and 5, an alternative embodiment of the securing structure is shown. Similarly, the securing structure includes four securing arms 422 extending outwardly from the base 42, and four fasteners 20 engaged with the securing arms 422, respectively. The securing arm 422 defines an aperture 426 for extension of the fastener 20 therethrough. The difference of this embodiment over the previous embodiment is as follows. The engaging portions 4222 extend vertically and downwardly from the outer ends of the supporting portions 428 of the securing arm 422, respectively. The opening 4220 has a width not smaller than the diameter of the main portion 242, but smaller than the diameter of the fixing portion 246 of the bolt 24. When the spring 22 is resiliently compressed towards the head portion 240 of the bolt 24, the head portion 240 and the upper part of the main portion 242 with the compressed spring 22 are located above the securing arm 422, the fixing portion 246 of the bolt 24 is located below the engaging portions 4222 of the securing arm 422, and the lower part of the main portion 242 without the compressed spring 22 confronts the opening 4220 between the engaging portions 4222 and can enter into the aperture 426 via the opening 4220. After the main portion 242 of bolt 24 moved into the aperture 426 entirely, the compressing force on the spring 22 is released and the spring 22 expands downwardly to abut the upper surface 4224 of the securing arm 422. The fixing portion 246 of the bolt 24 moves upwardly to engaging with the lower surface 4226 of the securing arm 422. The engaging portions 4222 of the securing arm 422 abut an outer circumferential surface 2460 of the fixing portion 246 of the bolt 24 of the fastener 20 to hold the fastener 20 in the aperture 426 reliably.

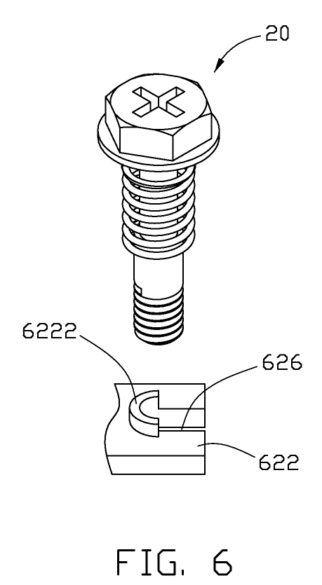

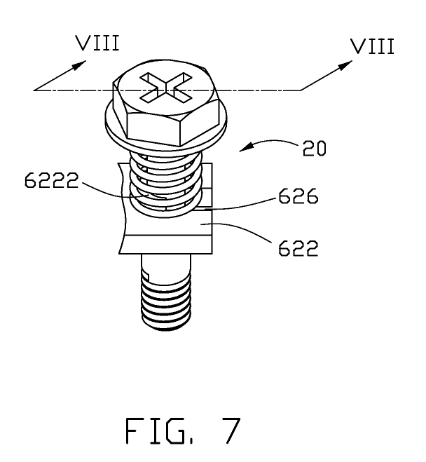

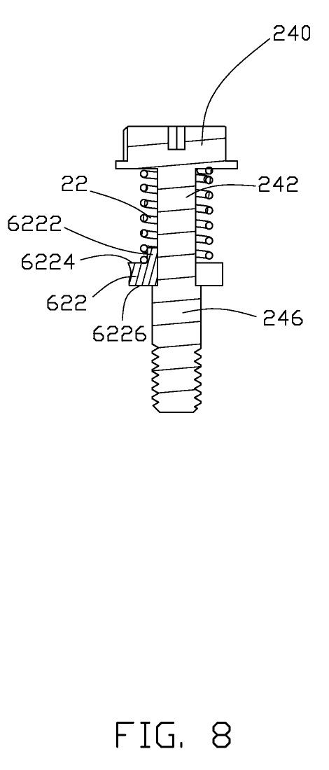

FIGS. 6-8 show a third embodiment of a portion of the securing structure. Similar to the first embodiment, the securing arm 622 defines a U-shaped aperture 626. The difference between this embodiment and the first embodiment is that the engaging portion 6222 extends upwardly from the securing arm 622 at the arc-shaped inner side of the aperture 626. The engaging portion 6222 is semi-circular, and a central axis of the engaging portion 6222 is collinear with that of the arc-shaped inner side of the aperture 626. An inner diameter of the engaging portion 6222 is equal to or a little greater than the width of the aperture 626, and an outer diameter of the engaging portion 6222 is equal to or a little smaller than an inner diameter of the spring 22. When the main portion 242 of the bolt 24 enters into the aperture 626, the compressing force on the spring 22 compressed to the head portion 240 is released; the spring 22 expands downwardly to surround the engaging portion 6222 and abut the upper surface 6224 of the securing arm 622. Meanwhile, the fixing portion 246 of the bolt 24 is lifted to abut the lower surface 6226 of the securing arm 622. Thus the fastener 20 is reliably held in the aperture 626 of the securing arm 622.

In the previous embodiments, each securing arm forms at least one engaging portion which engages with the spring/fixing portion of the bolt of the fastener to hold the fastener in the aperture; thus, the fasteners can be assembled to the heat sink directly and the clipping members of the conventional art are not necessary, whereby the fasteners can have a simple structure and accordingly a low cost. In addition, since assembly of the clipping members to the bolts is no longer needed, the fasteners can be pre-assembled to the heat sink more quickly. Accordingly, the present securing structure of the heat dissipation device does not have the disadvantage of the conventional art that the clipping members may engage with the fixing portions and drop from the bolts.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A heat dissipation device comprising:
a plurality of fasteners each comprising a bolt and a spring, the bolt comprising a main portion, a fixing portion formed at a bottom end of the main portion with a diameter greater than that of the main portion, and a head portion formed at a top end of the main portion with a diameter greater than that of the main portion, the spring being mounted around the main portion of the bolt;
a base forming a plurality of securing arms, each securing arm having an aperture extending inwardly from a free end thereof, a width of the aperture being not smaller than the diameter of the main portion and smaller than the diameter of the fixing portion of the bolt, the main portion of the bolt received in the aperture with the spring resiliently compressed between an upper surface of the securing arm and the head portion of the bolt, and the fixing portion of the bolt abutting a lower surface of the securing arm, at least one engaging portion extending from the securing arm around the aperture and engaging with the fastener to hold the fastener in the aperture of the securing arm;
a trunk extending through the base, the trunk having a bottom surface being configured for thermally attaching to a heat generating component; and
a fin unit located above the base, the fin unit attaching to an outer circumferential surface of the trunk closely.

2. The heat dissipation device of claim 1, wherein the aperture is U-shaped, and comprises an arc-shaped inner side and an open outer side communicating the aperture with an outside.

3. The heat dissipation device of claim 2, wherein the at least one engaging portion extends upwardly from the securing arm and is located closely adjacent to the inner side of the aperture, the spring of the fastener surrounding the engaging portion.

4. The heat dissipation device of claim 3, wherein the at least one engaging portion is semi-circular, an inner diameter of the at least one engaging portion being substantially equal to the diameter of the main portion of the bolt, an outer diameter of the at least one engaging portion being substantially equal to an inner diameter of the spring.

5. The heat dissipation device of claim 2, wherein the at least one engaging portion comprises a pair of engaging portions extending upwardly from the free end of the securing arm and located at two opposite sides of the aperture, an opening being defined between the pair of engaging portions with a width not smaller than the diameter of the main portion and smaller than the diameter of the spring, the pair of engaging portions engaging with an outer periphery of the spring.

6. The heat dissipation device of claim 2, wherein the at least one engaging portion comprises a pair of engaging portions extending downwardly from the free end of the securing arm and located at two opposite sides of the aperture, an opening being defined between the pair of engaging portions with a width not smaller than the diameter of the main portion and smaller than the diameter of the fixing portion of the bolt, the pair of engaging portions engaging with an outer circumferential surface of the fixing portion of the bolt.

7. The heat dissipation device of claim 1, wherein a circular hole is defined in the base with a diameter substantially equal to that of the trunk, a flange extending outwardly from a bottom end of the trunk, the flange having an outer diameter greater than the diameter of the circular hole, the trunk extending through the circular hole with the flange abutting a bottom side of the base.

8. The heat dissipation device of claim 1, wherein the fin unit comprises a cylinder attaching to the outer circumferential surface of the trunk closely, and a plurality of curved fins extending outwardly and integrally from the cylinder.

9. The heat dissipation device of claim 1, wherein the base is rectangular, and the securing arms extending outwardly from corners of the base.

10. A securing structure comprising:
a fastener comprising a bolt and a spring, the bolt comprising a main portion, a fixing portion formed at a bottom end of the main portion with a diameter greater than that of the main portion, and a head portion formed at a top end of the main portion with a diameter greater than that of the main portion, the spring being mounted around the main portion of the bolt; and
a securing arm having an aperture extending inwardly from a free end thereof, a width of the aperture being not smaller than the diameter of the main portion and smaller than the diameter of the fixing portion of the bolt, the main portion of the bolt received in the aperture with the spring resiliently compressed between an upper surface of the securing arm and the head portion of the bolt, and the fixing portion of the bolt abutting a lower surface of the securing arm, at least one engaging portion extending perpendicularly from the securing arm around the aperture and engaging with the fastener to hold the fastener in the aperture of the securing arm.

11. The securing structure of claim 10, wherein the aperture is U-shaped, and comprises an arc-shaped inner side and an open outer side communicating the aperture with an outside.

12. The securing structure of claim 11, wherein the at least one engaging portion comprises a pair of engaging portions extending downwardly from the free end of the securing arm and located at two opposite sides of the aperture, an opening being defined between the pair of engaging portions with a width not smaller than the diameter of the main portion and smaller than the diameter of the fixing portion of the bolt, the pair of engaging portions engaging with an outer circumferential surface of the fixing portion of the bolt.

13. The securing structure of claim 11, wherein the at least one engaging portion extends upwardly from the securing arm and is located closely adjacent to the inner side of the aperture, the spring of the fastener surrounding the engaging portion.

14. The securing structure of claim 13, wherein the at least one engaging portion is semi-circular, an inner diameter of the at least one engaging portion being substantially equal to the diameter of the main portion of the bolt, an outer diameter of the at least one engaging portion being substantially equal to an inner diameter of the spring.

15. The securing structure of claim 11, wherein the at least one engaging portion comprises a pair of engaging portions extending upwardly from the free end of the securing arm and located at two opposite sides of the aperture, an opening being defined between the pair of engaging portions with a width not smaller than the diameter of the main portion and smaller than the diameter of the spring, the pair of engaging portions engaging with an outer side of the spring.
